(19) United States
(12) Patent Application Publication
(10) Pub. No.: US 2012/0131428 A1
(43) Pub. Date: May 24, 2012

(54) WEB PAGE CRAWLING METHOD, WEB PAGE CRAWLING DEVICE AND COMPUTER STORAGE MEDIUM THEREOF

(75) Inventors: Yi-An TSAI, Taipei City (TW); Chien-Tsung Liu, Taipei City (TW); Jain-Shing Wu, Taipei City (TW)

(73) Assignee: INSTITUTE FOR INFORMATION INDUSTRY, Taipei (TW)

(21) Appl. No.: 12/959,064

(22) Filed: Dec. 2, 2010

(30) Foreign Application Priority Data
Nov. 22, 2010 (TW) 099140160

(51) Int. Cl. G06F 3/14

(52) U.S. Cl. 715/205

(57) ABSTRACT

A web page crawling method, a web page crawling device and a computer storage medium thereof are provided. The web page crawling method analyzes a web page to create an object list which comprises a dynamic triggering object according to a DOM. And it creates a triggering mission list which comprises at least one triggering event corresponding to the dynamic triggering object according to the object list. Then it triggers the web page to generate a triggered web page according to the at least one triggering event. Finally, it creates a web page link list of the dynamic triggering object according to a new link object of the triggered web page. In addition, the web page crawling device is configured to carry out the web page crawling method, and the computer storage medium executes the web page crawling method after it is loaded into the web page crawling device.

This application claims priority to Taiwan Patent Application No. 099140160 filed on Nov. 22, 2010, which is hereby incorporated by reference in its entirety.

### FIELD

The present invention relates to a web page crawling method, a web page crawling device and a computer storage medium thereof. More particularly, the web page crawling method, the web page crawling device and the computer storage medium thereof simulates triggering of a dynamic triggering event by creating a triggering mission list so as to collect dynamic triggering links of a web page.

### BACKGROUND

Web page crawling is a technology that can be used for web page vulnerability scanning, search engines, offline browsing or the like. By means of the web page crawling technology, a user is able to collect position of hyperlinks incorporated in a web page and various file links embedded in the web page so that more web page vulnerabilities can be found through the web page vulnerability scanning, more target positions can be searched out by the search engines and more offline messages can be browsed through offline browsing.

Conventional web page crawling technologies are generally classified into static web page crawling technologies and dynamic web page crawling technologies. The static web page crawling technologies are used to retrieve a static link of a webpage, and according to conventional static web page crawling technologies, an original file of the web page is analyzed and web page links and form information are retrieved according to keywords. The dynamic web page crawling technologies are used to retrieve a dynamic link of a web page, and according to conventional web page crawling technologies, the AJAX event triggering is utilized to collect dynamic web page links that are generated.

With rapid development of dynamic web page creation technologies such as Web 2.0, AJAX and JavaScript, dynamic web pages created by these technologies now have the dynamic event triggering ability. However, web pages, tables, links and etc triggered by dynamic events cannot be collected by the conventional web page crawling technologies. This causes missing in the collection process and, consequently, has an adverse effect on completeness of the subsequent web page vulnerability scanning, accuracy of the search engines and universality of the offline browsing. Specifically, for collection of links in dynamic web pages, the conventional web page crawling technologies generally have the following two shortcomings: (I) they can not collect links that are generated dynamically but don't send a request; (II) they can not collect links that are sent to different web pages depending on different content filled into a dynamic form. Thus, information security protection will become more difficult with the rise of dynamic web page technologies.

In view of this, an urgent need exists in the art to effectively overcome the shortcomings of conventional web page crawling technologies by completely collecting web pages, tables links and the like triggered by dynamic web pages, thereby to improve the information security protection and coverage of the dynamic web page crawling.

### SUMMARY

The objective of the present invention is to provide a web page crawling method, a web page crawling device and a computer storage medium thereof, which can effectively solve the problems of the prior art caused due to incapability to collect links that are generated dynamically but don't send a request and links that are sent to different web pages depending on different content filled into a dynamic form.

To achieve the aforesaid objective, the present invention provides a web page crawling method for a web page crawling device. The web page crawling device comprises a storage and a processor electrically connected to the storage. The web page crawling method comprises the following steps of: (a) enabling the processor to analyze a web page to create an object list in the storage according to a DOM, wherein the object list comprises a dynamic triggering object; (b) after the step (a), enabling the processor to create a triggering mission list in the storage according to the object list, wherein the triggering mission list comprises at least one triggering event corresponding to the dynamic triggering object; (c) after the step (b), enabling the processor to trigger the web page according to the at least one triggering event to generate a triggered web page; and (d) after the step (c), enabling the processor to create a web page link list of the dynamic triggering object in the storage according to a new link object of the triggered web page, wherein the new link object is not recorded in the object list.

To achieve the aforesaid objective, the present invention further provides a web page crawling device, which comprises a storage and a processor. The processor is configured to: analyze a web page to create an object list in the storage according to a document object model (DOM), wherein the object list comprises a dynamic triggering object; create a triggering mission list in the storage according to the object list, wherein the triggering mission list comprises at least one triggering event corresponding to the dynamic triggering object; trigger the web page according to the at least one triggering event to generate a triggered web page; and create a web page link list of the dynamic triggering object in the storage according to a new link object of the triggered web page, wherein the new link object is not recorded in the object list.

To achieve the aforesaid objective, the present invention further provides a computer storage medium, which stores a program for executing a web page crawling method for a web page crawling device. The web page crawling device comprises a storage and a processor electrically connected to the storage. When the program is loaded into the web page crawling device, the web page crawling method is executed. The program comprises: a code A for enabling the processor to analyze a web page to create an object list in the storage according to a DOM, wherein the object list comprises a dynamic triggering object; a code B for enabling the processor to create a triggering mission list in the storage according to the object list, wherein the triggering mission list comprises at least one triggering event corresponding to the dynamic triggering object; a code C for enabling the processor to trigger the web page according to the at least one triggering event to generate a triggered web page; and a code D for enabling the processor to create a web page link list of the dynamic triggering object in the storage according to a new link object of the triggered web page, wherein the new link object is not recorded in the object list.

According to the above descriptions, the present invention can create a triggering mission list comprising a dynamic triggering event by analyzing a web page and, according to the dynamic triggering event, trigger the web page to collect dynamic triggering links of the web page. Thereby, the present invention can effectively solve the problems of the prior art caused due to incapability to collect links that are generated dynamically but don't send a request and links that are sent to different web pages depending on different content filled into a dynamic form, thereby improving the information security protection and coverage of the dynamic web page crawling.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a web page crawling device 1 according to a first embodiment of the present invention;

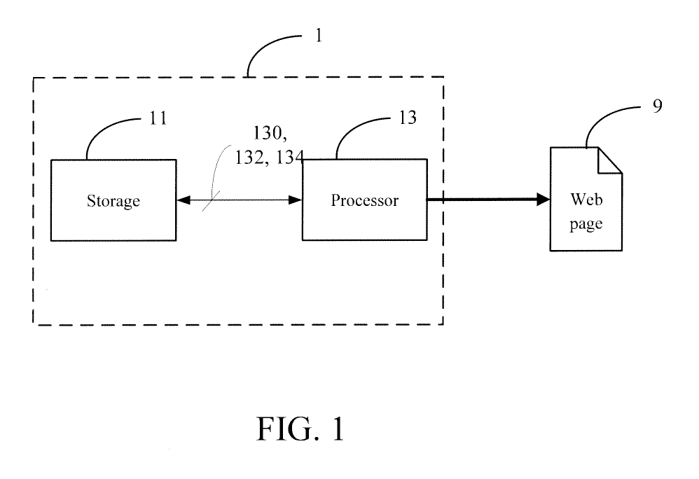

FIG. 2 is a flowchart of a second embodiment of the present invention;

FIG. 3A is a flowchart of a step S34; and

FIG. 3B is another flowchart of the step S34.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction; and dimensional relationships among individual elements in processor 13 triggers web page 9 according to the at least one triggering event to generate a triggered web page, and according to a new link object of the triggered web page, creates a web page link list 134 of the dynamic triggering object in storage 11. Here, the new link object is not recorded in object list 130.

Specifically, upon receiving web page 9, processor 13 analyzes web page 9 according to a DOM to obtain objects with a dynamic triggering ability in web page 9, and stores the objects thus obtained (i.e., the analysis result) into storage 11 in form of a list (i.e., the aforesaid object list 130). Dynamic triggering objects described in this embodiment may be classified into two kinds: one is of dynamic link triggering objects that don't send a request, and the other is of dynamic form triggering objects. When a dynamic link triggering object is triggered, it will further generate a new link path for a user of web page 9 to click; on the other hand, when a dynamic form triggering object is triggered, depending on data previously selected or filled in the form by the user, it will further generate a web page link corresponding to the data.

Next, to completely simulate possible triggering conditions, processor 13 determines all possible triggering events of dynamic triggering objects according to the dynamic triggering objects recorded in object list 130 stored in storage 11, and creates triggering mission list 132 in storage 11 for recording all the triggering events. It shall be appreciated that, because the dynamic triggering objects recorded in object list 130 may generate a number of triggering events, the dynamic triggering objects recorded in object list 130 correspond to at least one triggering event.

Then, processor 13 triggers web page 9 to simulate a triggering according to the triggering events recorded in triggering mission list 132, and generates a triggered web page which comprises a new link object resulting from the triggering. Specifically, when the dynamic triggering object is a dynamic link triggering object that does not send a request, the new link object has a corresponding web page link. After generating the triggered web page, processor 13 analyzes the triggered web page according to the DOM and further makes a comparison between the triggered web page that has been analyzed and web page 9. At this point, processor 13 can learn difference between the triggered web page and web page 9 and find that the new link object is not recorded in object list 130. Because this new link object is found by processor 13, the new link object is recorded into web page link list 132. Thus, coverage of the dynamic web page crawling gets improved.

Similarly, when the dynamic triggering object is a dynamic form triggering object, the new link object corresponds to different web page links depending on different content filled in the form. After generating the triggered web page, processor 13 analyzes the triggered web page according to the DOM and further makes a comparison between the triggered web page that has been analyzed and web page 9. At this point, processor 13 can learn difference between the triggered web page and web page 9 and find that the new link object is not recorded in object list 130. Then, by monitoring an Hyper Text Transport Protocol (HTTP) traffic of the triggered web page, processor 13 collects the web page link corresponding to the new link object. Finally, processor 13 adds the web page link to web page link list 132 in storage 11.

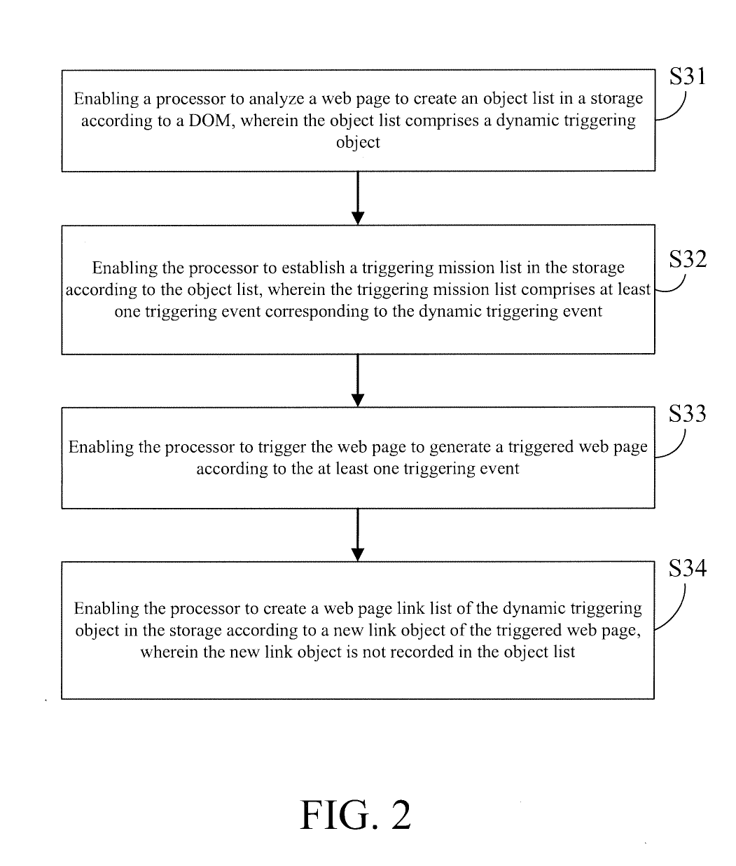

A second embodiment of the present invention is shown in FIG. 2, which is a flowchart of a web page crawling method for a web page crawling device as described in the first embodiment. The web page crawling device comprises a storage and a processor electrically connected to the storage, and analyzes a web page for web page crawling.

Furthermore, the web page crawling method of the second embodiment may also be implemented by a computer storage medium. When the computer storage medium is loaded into the web page crawling device, a plurality of codes of the computer storage medium will be executed to accomplish the web page crawling method described in the second embodiment. This computer storage medium may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

Referring to FIG. 2, step S31 is executed to enable the processor to analyze the web page to create an object list in the storage according to a DOM. The object list comprises a dynamic triggering object. Then, step S32 is executed to enable the processor to establish a triggering mission list in the storage according to the object list. The triggering mission list comprises at least one triggering event corresponding to the dynamic triggering event. Afterwards, step S33 is executed to enable the processor to trigger the web page to generate a triggered web page according to the at least one triggering event. Finally, step S34 is executed to enable the processor to create a web page link list of the dynamic triggering object in the storage according to a new link object of the triggered web page. The new link object is not recorded in the object list.

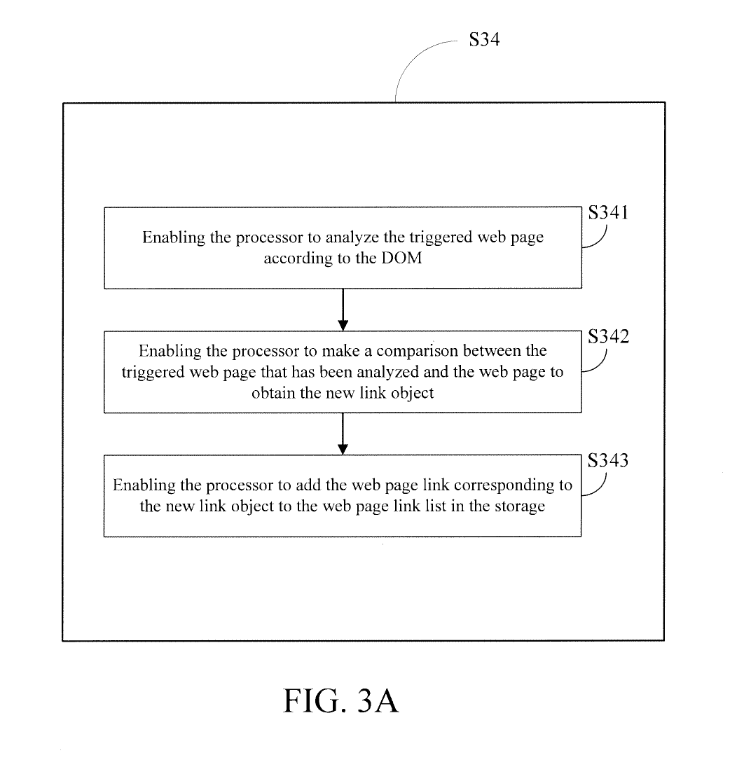

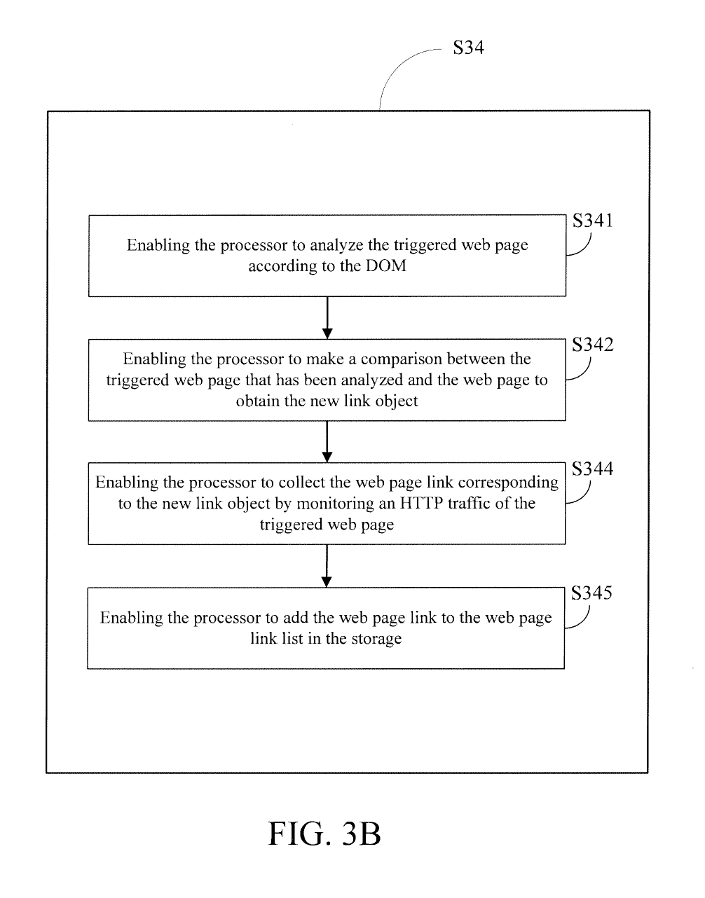

Specifically, when the dynamic triggering object is a dynamic link triggering object that doesn't make a request, step S34 comprises the following steps. As shown in FIG. 3A, step S341 is executed to enable the processor to, after generating the triggered web page, analyze the triggered web page according to the DOM. Then, step S342 is executed to enable the processor to make a comparison between the triggered web page that has been analyzed and the web page to obtain the new link object. Because the dynamic triggering object is a dynamic link triggering object that does not send a request, the new link object has a corresponding web page link. Finally, step S343 is executed to enable the processor to add the web page link corresponding to the new link object to the web page link list in the storage, so as to obtain a web page link list of the dynamic link triggering object.

On the other hand, when the dynamic triggering object is a dynamic form triggering object, the step S34 comprises the following steps. As shown in FIG. 3B, step S341 is executed to enable the processor to, after generating the triggered web page, analyze the triggered web page according to the DOM. Next, step S342 is executed to enable the processor to make a comparison between the triggered web page that has been analyzed and the web page to obtain the new link object. Because the dynamic triggering object is a dynamic form triggering object, the new link object corresponding to different web page links depending on different content filled in the form. Then, step S344 is executed to enable the processor to collect the web page link corresponding to the new link object by monitoring an HTTP traffic of the triggered web page. Finally, step S345 is executed to enable the processor to add the web page link to the web page link list in the storage to obtain a web page link list of the dynamic form triggering object.

It shall be appreciated that, in addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, by creating a triggering mission list, the web page crawling method of the present invention simulates a succession of steps of triggering a dynamic triggering event so as to collect dynamic triggering links of a web page. Furthermore, for a dynamic triggering object that is a dynamic link triggering object not sending a request and a dynamic triggering object that is a dynamic form triggering object, the present invention can also process them effectively in different ways respectively. Thereby, the problems of the prior art caused due to incapability to collect links that are generated dynamically but don't send a request and links that are sent to different web pages depending on different content filled into a dynamic form are effectively solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A web page crawling device, comprising:
a storage; and
a processor being electrically connected to the storage and configured to:
analyze a web page to create an object list in the storage according to a document object model (DOM), wherein the object list comprises a dynamic triggering object;
create a triggering mission list in the storage according to the object list, wherein the triggering mission list comprises at least one triggering event corresponding to the dynamic triggering object;
trigger the web page according to the at least one triggering event to generate a triggered web page; and
create a web page link list of the dynamic triggering object in the storage according to a new link object of the triggered web page;
wherein the new link object is not recorded in the object list.

2. The web page crawling device as claimed in claim 1, wherein the dynamic triggering object is a dynamic link triggering object that does not send a request so that the new link object has a corresponding web page link, the processor is configured to:
analyze the triggered web page according to the DOM;
compare the triggered web page with the web page to obtain the new link object after analyzing the triggered web page; and
add the web page link corresponding to the new link object into the web page link list in the storage.

3. The web page crawling device as claimed in claim 1, wherein the dynamic triggering object is a dynamic form triggering object so that the new link object corresponds to different web page links depending on different content filled into a form, and the processor is configured to:
analyze the triggered web page according to the DOM;
compare the triggered web page with the web page to obtain the new link object after analyzing the triggered web page;
collect the web page link corresponding to the new link object by monitoring an Hyper Text Transport Protocol (HTTP) traffic of the triggered web page; and
add the web page link into the web page link list in the storage.

4. A web page crawling method for use in a web page crawling device, the web page crawling device comprising a storage and a processor electrically connected to the storage, the web page crawling method comprising the following steps of:
(a) enabling the processor to analyze a web page to create an object list in the storage according to a DOM, wherein the object list comprises a dynamic triggering object;
(b) after the step (a), enabling the processor to create a triggering mission list in the storage according to the object list, wherein the triggering mission list comprises at least one triggering event corresponding to the dynamic triggering object;
(c) after the step (b), enabling the processor to trigger the web page according to the at least one triggering event to generate a triggered web page; and
(d) after the step (c), enabling the processor to create a web page link list of the dynamic triggering object in the storage according to a new link object of the triggered web page;
wherein the new link object is not recorded in the object list.

5. The web page crawling method as claimed in claim 4, wherein the dynamic triggering object is a dynamic link triggering object that does not send a request so that the new link object has a corresponding web page link, and the step (d) comprises the following steps of:
(d1) enabling the processor to analyze the triggered web page according to the DOM;
(d2) after the step (d1), enabling the processor to compare the triggered web page with the web page to obtain the new link object after analyzing the triggered web page; and
(d3) after the step (d2), enabling the processor to add the web page link corresponding to the new link object into the web page link list in the storage.

6. The web page crawling method as claimed in claim 4, wherein the dynamic triggering object is a dynamic form triggering object so that the new link object corresponds to different web page links depending on different content filled into a form, and the step (d) comprises the following steps of:
(d1) enabling the processor to analyze the triggered web page according to the DOM;
(d2) after the step (d1), enabling the processor to compare the triggered web page with the web page to obtain the new link object after analyzing the triggered web page;
(d4) after the step (d2), enabling the processor to collect the web page link corresponding to the new link object by monitoring an HTTP traffic of the triggered web page; and
(d5) after the step (d4), enabling the processor to add the web page link into the web page link list in the storage.

7. A computer storage medium, storing a program for executing a web page crawling method for use in a web page crawling device, the web page crawling device comprising a storage and a processor electrically connected to the storage, when the program is loaded into the web page crawling device, the program executing:
a code A for enabling the processor to analyze a web page to create an object list in the storage according to a DOM, wherein the object list comprises a dynamic triggering object;
a code B for enabling the processor to create a triggering mission list in the storage according to the object list, wherein the triggering mission list comprises at least one triggering event corresponding to the dynamic triggering object;
a code C for enabling the processor to trigger the web page according to the at least one triggering event to generate a triggered web page; and
a code D for enabling the processor to create a web page link list of the dynamic triggering object in the storage according to a new link object of the triggered web page;
wherein the new link object is not recorded in the object list.

8. The computer storage medium as claimed in claim 7, wherein the dynamic triggering object is a dynamic link triggering object that does not send a request so that the new link object has a corresponding web page link, and the code D comprises:
a code D1 for enabling the processor to analyze the triggered web page according to the DOM;
a code D2 for, subsequent to the code D1, enabling the processor to compare the triggered web page with the web page to obtain the new link object after analyzing the triggered web page; and
a code D3 for, subsequent to the code D2, enabling the processor to add the web page link corresponding to the new link object into the web page link list in the storage.

9. The computer storage medium as claimed in claim 7, wherein the dynamic triggering object is a dynamic form triggering object so that the new link object corresponds to different web page links depending on different content filled into a form, and the code D comprises:
a code D1 for enabling the processor to analyze the triggered web page according to the DOM;
a code D2 for, subsequent to the code D1, enabling the processor to compare the triggered web page with the web page to obtain the new link object after analyzing the triggered web page;
a code D4 for, subsequent to the code D2, enabling the processor to collect the web page link corresponding to the new link object by monitoring an HTTP traffic of the triggered web page; and
a code D5 for, subsequent to the code D4, enabling the processor to add the web page link into the web page link list in the storage.
